(19) United States
(12) Patent Application Publication
(10) Pub. No.: US 2026/0073332 A1
(43) Pub. Date: Mar. 12, 2026

(54) SYSTEMS AND METHODS FOR WORKFLOW RECOMMENDATION

(71) Applicant: Schlumberger Technology Corporation, Sugar Land, TX (US)

(72) Inventors: Valerian Guillot, Montpellier (FR); Hicham Arrou, Montpellier (FR); Zengpeng Zhou, Montpellier (FR); Sohaib Ouzineb, Montpellier (FR); Abdelkarim Rekik, Montpellier (FR)

(21) Appl. No.: 18/883,936

(22) Filed: Sep. 12, 2024

(51) Int. Cl. G06Q 10/0633

(52) U.S. Cl. CPC G06Q 10/0633; E21B 47/00; E21B 2200/20; G06Q 50/02

(57) ABSTRACT

A system may include processing circuitry and memory storing instructions, where the instructions, when executed by the processing circuitry, cause the processing circuitry to identify one or more tools to generate one or more workflows for analyzing one or more datasets associated with one or more well operations, generate a tool library based on the tools, and receive user input indicative of a property and a set of well measurements. The processing circuitry may also determine a plurality of workflows based on the property, the set of well measurements, and the tool library and generate a ranked list comprising the plurality of workflows based on one or more attributes. The processing circuitry may determine a predicted set of measurements for each workflow of the ranked list and instruct a user interface to display the ranked list and the predicted set of measurements for each workflow of the ranked list of workflows.

### BACKGROUND

The present disclosure generally relates to systems and methods for generating and ranking workflows for determining a set of measurements for a property of a hydrocarbon well site. More specifically, the present disclosure relates to providing a workflow system for generating and ranking workflows to determine a predicted set of measurements of property of the hydrocarbon well site based on various components.

When screening or evaluating hydrocarbon wells, a variety of different well measurements may be used to perform quantitative interpretations regarding the operations of the hydrocarbon wells. For instance, a set of well measurements may be interpreted by a workflow that generates a predicted set of measurements associated with a property of a well within a hydrocarbon site. The workflow may include applying the set of well measurements to one or more models (e.g., physics based model), determining and/or apply parameters to the models, filtering the well measurements using any suitable filter, and so on in order to determine the predicted set of measurements. Indeed, any number of components (e.g., tools) may be combined in any suitable way to generate any suitable number of workflows for determining one or more properties of the wells. In other words, the set of well measurements may be processed by a variety of different components. With this in mind, it should be understood that the identification and application of any particular workflow may be time consuming and/or resource intensive. As such, reviewing and ranking each workflow to determine the best applicable workflow for the set of well measurements may be challenging.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system include processing circuitry and memory storing instructions, where the instructions, when executed by the processing circuitry, cause the processing circuitry to identify one or more tools to generate one or more workflows for analyzing one or more datasets associated with one or more well operations, generate a tool library based on the tools, and receive user input indicative of a property and a set of well measurements. The processing circuitry may also determine a plurality of workflows based on the property, the set of well measurements, and the tool library and generate a ranked list comprising the plurality of workflows based on one or more attributes. The processing circuitry may determine a predicted set of measurements for each workflow of the ranked list and instruct a user interface to display the ranked list and the predicted set of measurements for each workflow of the ranked list of workflows.

The system of the preceding clause, wherein the instructions, when executed by the processing circuitry, cause the processing circuitry to determine the one or more attributes based on business inputs received via the user interface and historical data stored in a database.

The system of the preceding clause, wherein the instructions, when executed by the processing circuitry, cause the processing circuitry to receive an indication of adjusting at least one workflow of the ranked list and store the indication as historical data in the database.

The system of any preceding clause, wherein the instructions, when executed by the processing circuitry, cause the processing circuitry to instruct one or more components within a well associated with the set of well measurements to perform or adjust one or more operations based on the predicted set of measurements.

The system of any preceding clause, wherein the tools comprises one or more custom tools received from an external device.

The system of any preceding clause, wherein the instructions, when executed by the processing circuitry, cause the processing circuitry to determine the predicted set of measurements for each workflow of the ranked list by applying the set of well measurements to each workflow of the ranked list of workflows.

In an embodiment, a system may include processing circuitry and memory storing instructions, where the instructions, when executed by the processing circuitry, cause the processing circuitry to receive user input indicative of a property and a set of well measurements stored in a database via a user interface on a display, generate a plurality of workflows for determining the property using the set of well measurements based on a tool library storing one or more tools for generating a workflow, and generate a ranked list comprising the plurality of workflows based on one or more attributes. The processing circuitry may also determine a respective predicted set of measurements associated with the property for each respective workflow of the plurality of workflows and output each predicted set of measurements with the respective workflow in an order indicated by the ranked list on the display.

The system of the preceding clause, wherein the instructions, when executed by the processing circuitry, cause the processing circuitry to receive at least one custom analysis tool from an external device and generate or update the tool library with the at least one custom analysis tool and one or more built-in workflow tools stored in a database.

The system of any preceding clause, wherein the instructions, when executed by the processing circuitry, cause the processing circuitry to retrieve one or more business rules and historical data from a database and determine the one or more attributes based on the business rules and the historical data.

The system of the preceding clause, wherein the instructions, when executed by the processing circuitry, cause the processing circuitry to receive the one or more business rules from an external device or a cloud server.

The system of any preceding clause, wherein the instructions, when executed by the processing circuitry, cause the processing circuitry to receive user input indicative of adjusting a ranking of a workflow of the ranked list of workflows via the user interface and store the user input as the historical data.

The system of any preceding clause, wherein the instructions, when executed by the processing circuitry, cause the processing circuitry to generate a first workflow of the plurality of workflows by assembling one or more tools from the tool library based on the property and the set of well measurements.

The system of the preceding clause, wherein the instructions, when executed by the processing circuitry, cause the processing circuitry to receive user input indicative of selecting a workflow from the ranked list and populate the user interface with the workflow, the respective property associated with the workflow, and tools of the workflow.

The system of any preceding clause, wherein the instructions, when executed by the processing circuitry, cause the processing circuitry to populate the user interface with a dropdown menu comprising a plurality of properties for determination and receive the user input indicative of the property based on selection of the property from the plurality of properties of the dropdown menu.

The system of any preceding clause, wherein the instructions, when executed by the processing circuitry, cause the processing circuitry to assign a score to each workflow of the plurality of workflows based on the one or more attributes and generate the ranked list comprising the plurality of workflows ranked from a highest score to a lowest score.

The system of any preceding clause, wherein the tool library comprises a model, an equation, a variable, a filter, or any combination thereof.

The system of any preceding clause, wherein the instructions, when executed by the processing circuitry, cause the processing circuitry to instruct one or more components within a well associated with the set of well measurements to perform or adjust an operation based on the predicted set of measurements.

In an embodiment, a method may include by processing circuitry, identifying one or more tools to generate one or more one or more workflows for analyzing one or more datasets associated with one or more well operations, generating a tool library based on the one or more tools, and receiving user input indicative of a property and a set of well measurements. The method may also retrieve, via the processor, the set of well measurements based on the user input, determine, via the processor, a plurality of workflows based on the property, the set of well measurements, and the tool library, and generate, via the processor, a ranked list comprising the plurality of workflows based on one or more attributes. The method may also determine, via the processor, a predicted set of measurements for each workflow of the ranked list and instruct, via the processor, a user interface to display the ranked list and the predicted set of measurements for each workflow of the ranked list of workflows.

The method of the preceding clause including retrieving, via the processor, one or more business rules and historical data from a database and determining, via the processor, the one or more attributes based on the business rules and the historical data.

The method of the preceding clause including receiving, via the processor, user input indicative of adjusting a ranking of a workflow of the ranked list of workflows via the user interface and storing, via the processor, the user input as the historical data.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic diagram of an example hydrocarbon site that may produce and process hydrocarbons, in accordance with embodiments of the present disclosure;

FIG. 2 illustrates a block diagram of a workflow system that may be employed in and/or receive measurements from the hydrocarbon site of FIG. 1, in accordance with embodiments of the present disclosure;

FIG. 3 illustrates a data flow diagram for generating a ranked list of workflows by the workflow system of FIG. 2, in accordance with embodiments of the present disclosure;

FIG. 4 illustrates a GUI presenting an input box for accepting a property for workflow generation on the workflow system of FIG. 2, in accordance with embodiments of the present disclosure;

FIG. 5 illustrates a GUI presenting a workflow on the workflow system of FIG. 2, in accordance with embodiments of the present disclosure;

FIG. 6 illustrates a GUI presenting a ranked list of workflows on the workflow system of FIG. 2, in accordance with embodiments of the present disclosure; and

FIG. 7 illustrates a flow diagram of the workflow system of FIG. 2 generating a ranked list including one or more workflows, in accordance with embodiments of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members. ”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Hydrocarbon well sites (e.g., hydrocarbon wells, wells) may include a number of components that facilitate the extraction, processing, and distribution of hydrocarbons (e.g., oil) from a well or a well site. The components may generate different sets of well measurements used to determine various properties (e.g., porosity, permeability, saturation) of the hydrocarbon well site. For instance, a system may receive and interpret a set of well measurements from the components based on a workflow. The workflow may include various tools (e.g., models, rules, filters, algorithms) to determine a predicted set of measurements associated with the property of the hydrocarbon well. Indeed, any number of tools may be combined in any suitable way to generate any suitable number of workflows to determine the predicted set of measurements of the hydrocarbon well. Moreover, reviewing and ranking each workflow to determine a best applicable workflow to determine the predicted set of measurements for the set of well measurements may be time-consuming and/or resource-intensive.

Embodiments of the present disclosure are directed to a workflow system that identifies workflows that may be applicable to a dataset (e.g., set of well measurements) and ranks the identified workflows based on a number of variables. With this in mind, the workflow system may receive an output parameter (e.g., property) related to the operations of a well, such as production changes, reservoir locations, and/or improve efficiencies in production operations, and the like from a user via a user interface. For example, the output parameter may include shale volume fraction, quartz volume fraction, lithology, permeability, water saturation, shear slowness, porosity, and so on.

The workflow system may determine and/or identify workflows that may be employed to acquire a predicted set of measurements associated with the output parameter based on available well measurements. For example, the workflow system may identify one or more workflows to determine the predicted set of measurements associated with the output parameter based on a set of well measurements and a workflow library. In certain instances, the workflow library may include built-in workflows provided by a manufacturer, software provider, and/or designer and custom workflows generated by a user. In other instances, the workflow library may include tools for generating a workflow. As such, the workflow system may have access to a wide variety of workflows that may be applied to various inputs, such as the set of well measurements.

After generating and/or identifying the workflows, the workflow system may rank the workflows based on various attributes. For instance, the workflow system may use historical data and/or business rules to identify various attributes for ranking the workflows and/or create an association between each of the workflows, the property, and so on. The attributes may include a frequency of use of the workflow for a similar dataset by a number of users, a utilization of certain well measurements (e.g., a first set of well measurements vs a second set of well measurements), and operating procedures employed by organizations that seeks the data, and the like. The workflow system may generate a list of ranked workflows including each generated and/or identified workflow and a respective predicted set of measurements associated with the selected property. The workflow system may also display the ranked list of workflows and the respective predicted set of measurements on a user interface. A user may view the ranked list of workflows for an input parameter (e.g., the dataset, the set of well measurements) and an output parameter for each workflow of the list of workflows. As such, the workflow system may generate one or more workflows based on the output parameter and the set of well measurements, rank the one or more workflows to generate a ranked list of workflows, determine a respective predicted set of measurements for each workflow of the ranked list of workflows, and display the ranked list of workflows and the respective predicted set of measurements with little or no user intervention. Accordingly, the workflow system may improve operations of generating and/or ranking workflows, identifying a best applicable workflow for the set of measurements, determining a property from set of well measurements, and so on.

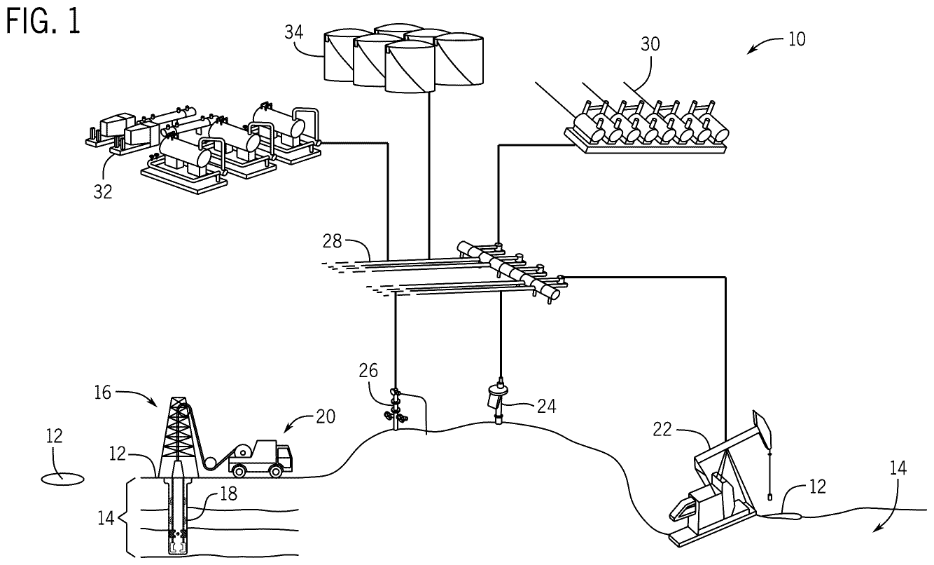

By way of introduction, FIG. 1 illustrates a schematic diagram of an example hydrocarbon site 10 where hydrocarbon products, such as crude oil and natural gas, may be extracted from the ground, processed, and stored. In accordance with the present embodiments, the hydrocarbon site 10 may include a number of components or facilities that correspond to wells, processing facilities, collection components, distribution networks, and the like. During the design phase of planning for the types of components to use at the hydrocarbon site 10, the locations of the components at the hydrocarbon site 10, and other design properties, a variety of factors are taken under consideration.

The hydrocarbon site 10 may include a number of wells 12 disposed within a geological formation. As used herein, wells 12 may generally refer to physical components such as the drilling platform 16 and wellbore 18 and/or the general area of the reservoir in which extraction is desired (e.g., a reservoir well section). In certain instances, the wells 12 may generate measurements (e.g., set of well measurements) that may be interpreted to determine properties of the wells 12 for various operations. For example, drilling operations may include drilling the wellbore 18, injecting drilling fluids into the wellbore 18, performing casing operations within the wellbore 18, and the like. For example, the present embodiments are directed to a workflow system that identifies and/or ranks workflows that generate properties of the well 12 for identifying areas of interest of the wellbore 18 for perforation, thereby improving the drilling operations. In addition to including the drilling platform 16, the hydrocarbon site 10 may include surface equipment 20 that may carry out certain operations, such as cement installation operation, well logging operations to detect conditions of the wellbore 18, and the like. As such, the surface equipment 20 may include equipment that store cement slurries, drilling fluids, displacement fluids, spacer fluids, chemical wash fluids, and the like. The surface equipment 20 may include piping and other materials used to transport the various fluids described above into the wellbore 18. The surface equipment 20 may also include pumps and other equipment (e.g., batch mixers, centrifugal pumps, liquid additive metering systems, tanks, etc.) that may fill in the interior of a casing string with the fluids discussed above.

In addition to the equipment used for drilling operations, the hydrocarbon site 10 may include a number of well devices that may control the flow of hydrocarbons being extracted from the wells 12. For instance, the well devices in the hydrocarbon site 10 may include pumpjacks 22, submersible pumps 24, well trees 26, and the like. The pumpjacks 22 may mechanically lift hydrocarbons (e.g., oil) out of the well 12 when a bottom hole pressure of the well 12 is not sufficient to extract the hydrocarbons to the surface. The submersible pump 24 may be an assembly that may be submerged in a hydrocarbon liquid that may be pumped. As such, the submersible pump 24 may include a hermetically sealed motor, such that liquids may not penetrate the seal into the motor. Further, the hermetically sealed motor may push hydrocarbons from underground areas or the reservoir to the surface. The well trees 26 may be an assembly of valves, spools, and fittings used for natural flowing wells. As such, the well trees 26 may be used for an oil well, gas well, water injection well, water disposal well, gas injection well, condensate well, and the like. By way of reference, the wells 12 may be part of a first hierarchical level and the well devices that extract hydrocarbons from the wells 12 may be part of a second hierarchical level above the first hierarchical level. Each hierarchical level may include a number of components and the presently disclosed techniques may account for these levels when determining the design plans for the hydrocarbon site 10.

After the hydrocarbons are extracted from the surface via the well devices, the extracted hydrocarbons may be distributed to other devices via a network of pipelines 28. That is, the well devices of the hydrocarbon site 10 may be connected together via a network of pipelines 28. In addition to the well devices described above, the network of pipelines 28 may be connected to other collecting or gathering components, such as wellhead distribution manifolds 30, separators 32, storage tanks 34, and the like.

In some embodiments, the pumpjacks 22, the submersible pumps 24, well trees 26, wellhead distribution manifolds 30, separators 32, and storage tanks 34 may be connected together via the network of pipelines 28. The wellhead distribution manifolds 30 may collect the hydrocarbons that may have been extracted by the pumpjacks 22, the submersible pumps 24, and the well trees 26, such that the collected hydrocarbons may be routed to various hydrocarbon processing or storage areas in the hydrocarbon site 10. The separator 32 may include a pressure vessel that may separate well fluids produced from oil and gas wells into separate gas and liquid components. For example, the separator 32 may separate hydrocarbons extracted by the pumpjacks 22, the submersible pumps 24, or the well trees 26 into oil components, gas components, and water components. After the hydrocarbons have been separated, each separated component may be stored in a particular storage tank 34. The hydrocarbons stored in the storage tanks 34 may be transported via the pipelines 28 to transport vehicles, refineries, and the like.

Although the hydrocarbon site 10 is described above with certain components, it should be understood that the hydrocarbon site 10 may include additional, fewer, or different components. For example, although discussed above in relation to a hydrocarbon site 10 on land, present embodiments may also include analysis of off-shore hydrocarbon sites 10 and the components thereof. That is, the embodiments described herein are directed to identifying intervals of interest for any suitable hydrocarbon site that may include various types of components that is related to the production and distribution of hydrocarbons. In this way, the components depicted in FIG. 1 are provided as an example context in which the embodiments described herein may be implemented. As such, the embodiments of this disclosure should not be limited to the components listed in FIG. 1.

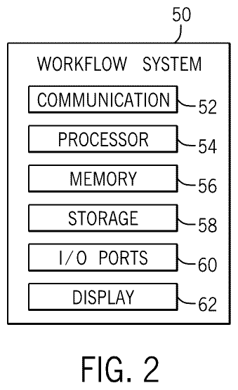

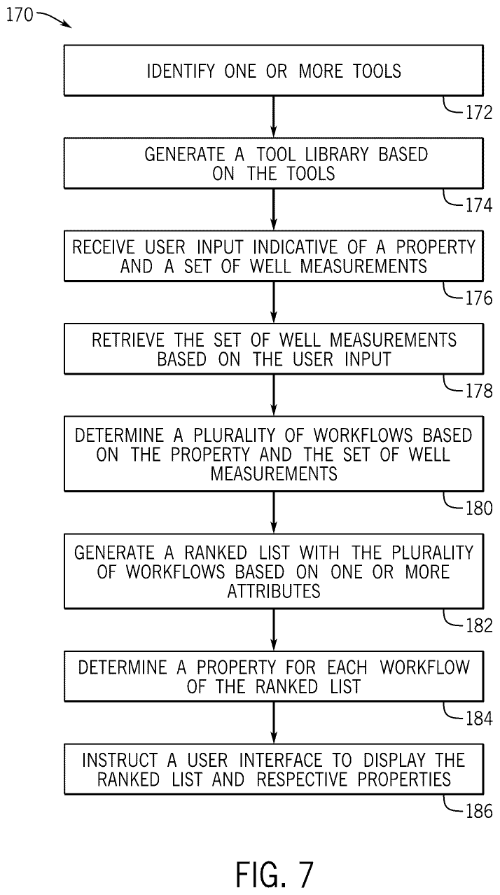

Keeping this in mind, the present embodiments described herein may include systems and methods for identifying and/or ranking workflows for determining a predicted set of measurements associated with a property of the well 12 for drilling and/or production operations. For example, a workflow system 50, as presented in FIG. 2, may receive a property for determination via a user interface, identify one or more workflows based on the property and a set of well measurements, and generate a list of ranked workflows according to a process that will be described in greater detail below with respect to FIG. 7.

Referring now to FIG. 2, the workflow system 50 may include any suitable computing device, cloud-computing device, or the like and may include various components to perform various analysis operations. As shown in FIG. 2, the workflow system 50 may include a communication component 52, a processor 54, a memory 56, a storage component 58, input/output (I/O) ports 60, a display 62, and the like. The communication component 52 may be a wireless or wired communication component that may facilitate communication between different monitoring systems, gateway communication devices, various control systems, and the like. The processor 54 may be any type of computer processor or microprocessor capable of executing computer-executable code. The memory 56 and the storage component 58 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 54 to perform the presently disclosed techniques. The memory 56 and the storage component 58 may also be used to store data received via the I/O ports 60, data analyzed by the processor 54, or the like.

The I/O ports 60 may be interfaces that couple to various types of I/O modules such as sensors, programmable logic controllers (PLC), and other types of equipment. For example, the I/O ports 60 may serve as an interface to pressure sensors, flow sensors, temperature sensors, and the like. As such, the workflow system 50 may receive data associated with a well via the I/O ports 60. The I/O ports 60 may also serve as an interface to enable the workflow system 50 to connect and communicate with surface instrumentation, servers, and the like.

The display 62 may include any type of electronic display such as a liquid crystal display, a light-emitting-diode display, and the like. As such, data acquired via the I/O ports and/or data analyzed by the processor 54 may be presented on the display 62, such that the workflow system 50 may present designs for hydrocarbon sites 10 for view. In certain embodiments, the display 62 may be a touch screen display or any other type of display capable of receiving inputs from an operator. Although the workflow system 50 is described as including the components presented in FIG. 2, the workflow system 50 should not be limited to including the components listed in FIG. 2. Indeed, the workflow system 50 may include additional or fewer components than described above.

With the foregoing in mind, the workflow system 50 may identify workflows that may be applicable to a set of well measurements and rank the identified workflows based on various attributes to improve drilling and/or production operations. For example, the workflow system 50 may generate a predicted set of measurements based on a workflow of the ranked list of workflows and the set of well measurements. The workflow system 50 may also instruct one or more components within a well of the hydrocarbon site 10 to perform or adjust an operation, such as perforating an area within the well based on the predicted set of measurements associated with the well. In other instances, the workflow system 50 may provide an indication to one or more output devices to move positions within the hydrocarbon site to an interval of interest, an area for perforation, or both. As such, the workflow system 50 may perform operations to improve drilling and/or production operations within a hydrocarbon site 10.

The workflow system 50 may receive a property and generate a ranked list of workflows applicable for determining a predicted set of measurements associated with the property. For example, the workflow system 50 may query a tool library to identify one or more workflows applicable to a set of well measurements based on the property. The workflow system 50 may rank the workflows based on historical data and/or business rules from a server and/or a database to identify attributes for ranking the workflows. In this way, the workflow system 50 may generate a ranked list of workflows that may be useful for a user to determine intervals of interest within a well (e.g., the well 12, the wellbore 18). The workflow system 50 may also determine the predicted set of measurements associated with the property for the well based on each respective workflow in the ranked list of workflows. In certain instances, the workflow system 50 may receive user inputs via a user interface indicative of adjusting a ranking of the workflows. For example, the user input may indicate a third ranked workflow being moved to be a first ranked workflow. The workflow system 50 may store the user input as historical data in a database for subsequent retrieval. In this way, the workflow system 50 may continuously identify and/or adjust the attributes used to rank the workflows and improve operations related to generating the ranked list of workflows, thereby reducing an amount of time and/or an amount of resources for generating a ranked list of workflows.

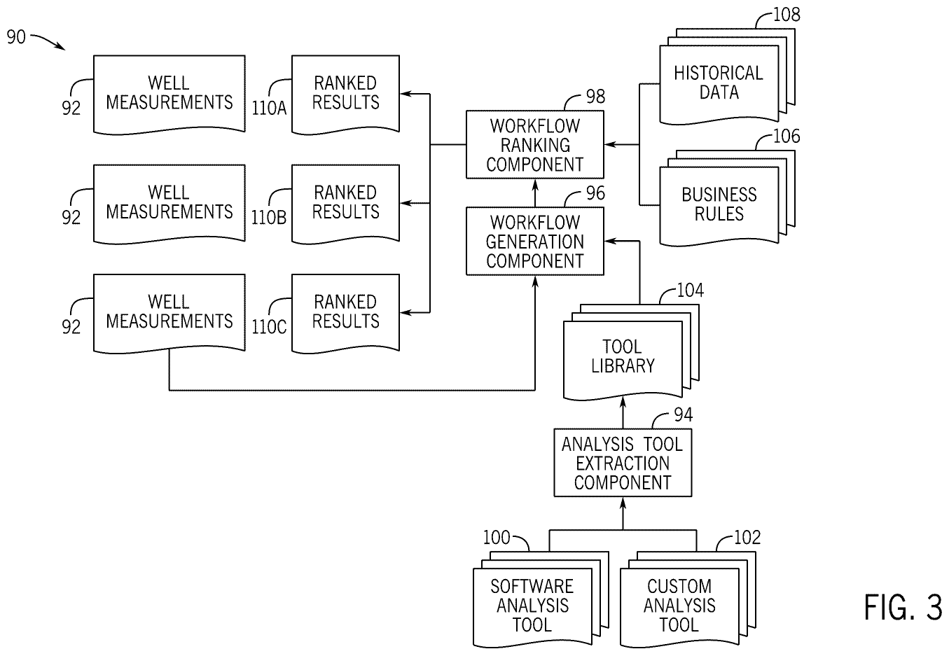

FIG. 3 illustrates a data flow diagram 90 for generating a ranked list of workflows in accordance with embodiments described herein as performed by the workflow system 50. As discussed herein, the workflow system 50 may receive an output parameter related to operations of a well, such as for determining production changes, identifying reservoir locations, and/or improving efficiencies in production operations from a user via a display 62. The workflow system 50 may determine or identify workflows that may be employed to acquire (e.g., determine) the output parameter based on available input parameters (e.g., a set of well measurements). For example, the workflow system 50 may include an analysis tool extraction component 94, a workflow generation component 96, and a workflow ranking component 98. Although the analysis tool extraction component 94, the workflow generation component 96, and the workflow ranking component 98 are illustrated as separate components in FIG. 3, it may be understood that the components may be implemented by one component (e.g., one processor), one processing device, and/or a cloud-based server. In other embodiments, the components of the workflow system 50 may be implemented on different processing devices and/or by different processors.

The workflow system 50 may query various tools (e.g., a software analysis tool 100, a custom analysis tool 102). In particular, the analysis tool extraction component 94 may query a software analysis tool 100 and/or a custom analysis tool 102 at a time prior to workflow generation and/or ranking. The software analysis tool (e.g., workflow tool) 100 and/or the custom analysis tool (e.g., custom workflow tool) 102 may built-in (e.g., pre-loaded) workflows provided by a manufacturer, software provider, and/or designer that may be distributed to a number of users. The software analysis tool 100 and/or the custom analysis tool 102 may be stored on a cloud-server, a remote server, a database, a memory (e.g., the memory 56), a storage (e.g., the storage component 58), or the like. For example, the software analysis tool 100 may include workflows provided by a manufacturer and stored on the memory and/or storage of the workflow system 50 during manufacturing. In another example, the software analysis tool 100 may be downloadable from a cloud repository and be used by the workflow system 50, bundled into an install package and/or update package, and the like. The custom analysis tool 102 may include custom workflows created (e.g., generated) by users of the workflow system 50. The workflow system 50 may receive the custom analysis tool 102 via the communication component 52 and user input. The custom analysis tool 102 may be stored on an external device, such as a client device, communicatively coupled to the workflow system 50 and executed by the workflow system 50. In certain instances, the custom analysis tool 102 may sharable with other users. For example, a user may load and store the custom analysis tool 102 in the memory and/or the storage component of the workflow system 50. The workflow system 50 may receive user input indicative of sharing the custom analysis tool 102 and upload the custom analysis tool 102 to a cloud repository for downloading by other users.

Although the illustrated example of FIG. 3 includes a software analysis tool 100 and a custom analysis tool 102, in certain instances, the workflow system 50 may query multiple software analysis tools 100 and multiple custom analysis tools 102. It may be understood that any suitable number of software analysis tools 100 and/or custom analysis tools 102 may be queried by the workflow system 50 to generate the tool library 104. Moreover, the software analysis tools 100 and/or custom analysis tools 102 may be updated, adjusted, added, and/or removed from the workflow system 50 over time and/or use by the user.

After querying the various tools, the workflow system 50 may store the identified workflows in an tool library (e.g., workflow library) 104. For example, the analysis tool extraction component 94 may generate the tool library 104 using the software analysis tool 100 and/or the custom analysis tool 102 prior to workflow generation and/or ranking. The tool library 104 may include a variety of workflows that may be applied to different sets of well measurements 92 and/or used for determining different predicted sets of measurements associated with different properties. In certain instances, the workflow system 50 may receive updates to the workflows and/or new workflows for storage in the tool library 104. The tool library 104 may be stored in a cloud server, a database, a memory, a storage component, and the like. For example, the tool library 104 may include a cloud repository and the workflows may be downloadable from the cloud repository for use by the workflow system 50, bunded into an install package and/or update package, stored in the memory and/or storage component of the workflow system 50, and the like. To generate the workflows, the workflow system 50 may identify one or more applicable workflows within the tool library 104 based on the set of well measurements 92 and/or the property.

Additionally or alternatively, the tool library 104 may include different tools for generating workflows. For example, the software analysis tool 100 and/or the custom analysis tool 102 may include models (e.g., physics-based models, machine learning models, deep learning models), algorithms (e.g., equations), filters (e.g., bandpass, low pass), variables, parameters, and so on that may be stored in the tool library 104 and used to form a workflow. By way of example, the workflow system 50 may link together one or more models, algorithms, and/or filters to form a workflow that may be applied to a set of well measurements 92. As such, the tool library 104 may include different tools used by the workflow system 50 to generate a workflow applied to a set of well measurements 92.

The workflow system 50 may receive and/or retrieve the set of well measurements 92 to generate one or more workflows based on a property. For example, the workflow system 50 may receive a property for determination via a user and a display (e.g., the display 62). The property may include a property of a well in the hydrocarbon site used for drilling and/or production operations. For example, the property may include shale volume fraction, quartz volume fraction, lithology, permeability, water saturation, shear slowness, porosity, and the like for the well. The workflow generation component 96 may identify and/or generate workflows that may be employed to acquire the parameter based on available well measurements 92. For example, the workflow generation component 96 may identify one or more workflows within the tool library 104 based on the set of well measurements 92 and the property. In another example, the workflow generation component 96 may generate the workflows by linking together respective components (e.g., tools) for one set of well measurements 92 and one parameter. For example, the workflow generation component 96 may generate a first workflow by applying set of well measurements to a model, identifying one or more parameters based on the model, filtering the one or more parameters, and generating a first property of the well by applying the one or more parameters to an algorithm. In another example, the workflow generation component 96 may generate a second workflow by filtering the set of well measurements 92, applying the well measurements to two or more models, and identifying a second property based on the two or more models. The first property and the second property may be the same property with different values as determined based on the first workflow and the second workflow, respectively.

The workflow system 50 may generate a ranked list of workflows with the identified and/or generated workflows. In particular, the workflow ranking component 98 may receive the workflows from the workflow generation component 96 and rank the workflows based on attributes of business rules 106, historical data 108, or both. The business rules 106 may correspond to ranking guidelines, operating procedures associated with a business (e.g., company of the user, association of the user), and so on. For example, the workflow system 50 may receive the business rules via a user from an external device, user input via a display, a cloud repository, or the like. The historical data 108 may include stored user input (e.g., adjustments made by the user to previous ranked lists), user preferences, stored ranked lists for similar types of well measurements, and the like. In certain instances, the workflow system 50 may store a user profile associated with a user and store previous adjustments made by the user, preferences of the user, frequency used tools by the user, and so on. The workflow ranking component 98 may analyze the business rules 106 and/or the historical data 108 to identify attributes for ranking the workflows. The attributes may include a frequency of use of the workflow for similar types of well measurements, a utilization of certain well measurements, and/or operating procedures employed by the business seeking the data, and the like.

The workflow system 50 may apply the attributes to each of the workflows to generate the ranked list of workflows including a first ranked result 110A, a second ranked result 110B, and/or a third ranked result 110C, as illustrated in FIG. 3, on a user interface. For example, the historical data 108 may be indicative of a user preference for interpreting well measurements based on an effective porosity density model, and workflow ranking component 98 may rank workflows with the effective porosity density model higher on the ranked list of workflows in comparison to workflows without the effective porosity density model. In another example, the business rules 106 may indicate a preference for workflows using a threshold amount of custom software and the workflow ranking component 98 may rank workflows utilizing more custom software in the workflow higher on the ranked list of workflows in comparison to workflows using less custom software. In this way, the workflow system 50 may automatically generate and rank workflows for determining a predicted set of measurements associated with a property and a set of well measurements 92 based on the business rules 106 and/or the historical data 108.

The workflow system 50 may display the ranked list of workflows on the display 62. Additionally or alternatively, the workflow system 50 may display the tools used to within each respective workflow, the property determined based on each respective workflow, or both. As such, a user may view the ranked list of workflows including, for example, a first ranked result (e.g., a first workflow of the ranked list of workflows) 110A, a second ranked result (e.g., a second workflow of the ranked list of workflows) 110B, and a third ranked result (e.g., a third workflow of the ranked list of workflows) 110C. In certain instances, the workflow system 50 may receive user input indicative of adjusting a ranking (e.g., position) of a workflow in the ranked list of workflows. For example, the workflow system 50 may receive user input indicative of moving the third ranked result 110C to be position of the first ranked result 110A. The workflow system 50 may update the ranked list of workflows on the display and store the user input as historical data 108. The workflow system 50 may identify attributes of the adjustment, such as a preference for certain types of well measurements, tools, and so on. As such, the workflow system 50 may take into account the adjustment when ranking subsequent workflows. Accordingly, the workflow system 50 may improve operations of generating and/or ranking workflows, identifying a best applicable workflow for the set of well measurements 92, determining a predicted set of measurements associated with a property from the set of well measurements 92, and so on.

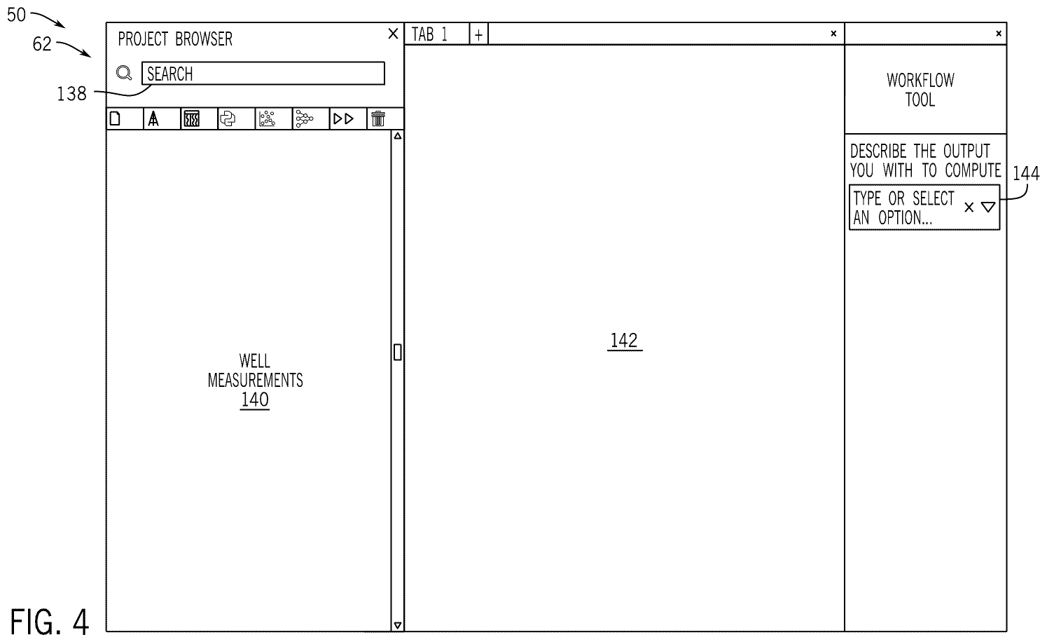

FIG. 4 illustrates a graphical user interface (GUI) 138 presenting an input box 144 for receiving a property for workflow generation on the workflow system 50. The GUI 138 includes a first display portion 140 for displaying stored sets of well measurements 92, a second display portion 142 for displaying a selected set of well measurements 92, and/or a selected property, an input box 144 for receiving a property for determination.

The first display portion 140 may display one or more sets of well measurements 92 stored in the storage component 58 of the workflow system 50. The workflow system 50 may display a set of well measurements 92 in the second display portion 142 based on a user selection. For example, the second display portion 142 may display values of the selected set of well measurements 92, a type of well associated with the selected set of well measurements 92, a date of the selected set of well measurements 92, and so on. For example, a hydrocarbon site 10 may include wells monitored by different types of components and/or a different number of components. A first set of wells may be monitored by more sophisticated components and/or more components in comparison to a second set of wells. As such, well measurements associated with first set of wells may be more complete and/or readily used for workflows and/or property determination in comparison to well measurements associated with the second set of wells.

The input box 144 may include a drop down menu including various properties that may be determined by the workflow system 50. By way of example, the properties may include a shale volume fraction, quartz volume fraction, lithology, permeability, water saturation, shear slowness, porosity, and so on. The workflow system 50 may receive a property for workflow generation via user selection of the property from the input box 144. In other instances, the input box 144 may receive a string of text from a user indicative of the property for workflow generation.

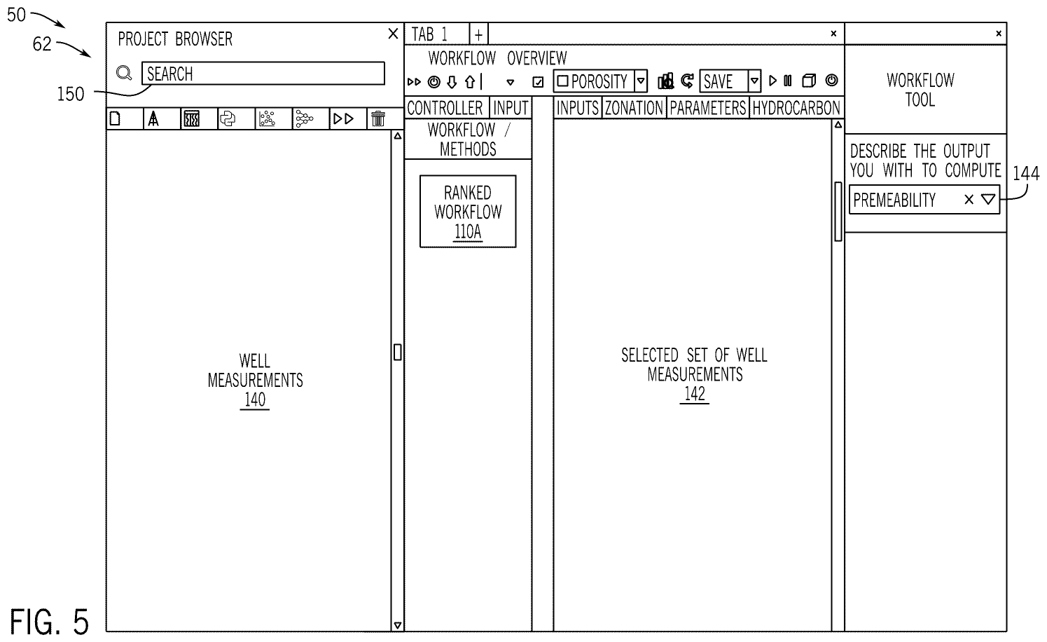

FIG. 5 illustrates the GUI 150 presenting a first ranked result 110A on the workflow system 50. The GUI 150 of FIG. 5 is substantially similar to the GUI 138 of FIG. 4, except that the GUI 150 of FIG. 5 includes a selected set of well measurements 92 being displayed by the second display portion 142 and a first ranked result 110A displayed proximate to the second portion. As discussed herein, the workflow system 50 may identify one or more workflows based on the selected property and the selected set of well measurements 92, generate a ranked list of workflows based on various attributes, and determine a predicted set of measurements associated with the property for each workflow of the ranked list of workflows. The workflow system 50 may determine the predicted set of measurements for each workflow in the ranked list of workflows based on a ranking of the workflow. For example, the workflow system 50 may generate a first predicted set of measurements using a first ranked result (e.g., a first workflow) 110A of the ranked list of workflows and the selected set of well measurements, a second predicted set of measurements using a second ranked result (e.g., a second workflow) 110B of the ranked list of workflows, and the set of well measurements 92, and so on.

In certain instances, the workflow system 50 may display the predicted set of measurements and a workflow used to determine the predicted set of measurements upon completion of the determination. For example, the workflow system 50 may instruct the GUI 138 to display a first ranked result 110A and the determined predicted set of measurements adjacent to the first ranked result 110A in response to the workflow system 50 determining the predicted set of measurements associated with the property of a well of the hydrocarbon site 10 using the first ranked result 110A. That is, the workflow system 50 may determine the predicted set of measurements by applying the selected set of well measurements 92 to the first ranked result 110A in the ranked list of workflows. The workflow system 50 may display tools (e.g., components) of the first ranked result 110A. For example, the first ranked result 110A may include a mathematical operation and a model and the workflow system 50 may display a list including the two tools of the first ranked result 110.

The workflow system 50 may populate the second display portion 142 with the predicted set of measurements. In other instances, the workflow system 50 may populate the second display portion 142 with the tools used in the first ranked result 110A in response to user selection of the first ranked result 110A. Additionally or alternatively, the workflow system 50 may populate the second display portion 142 with components of a tool used in the first ranked result 110A in response to user selection of the tool. As such, the workflow system 50 may provide a visual indication of the workflow to the user.

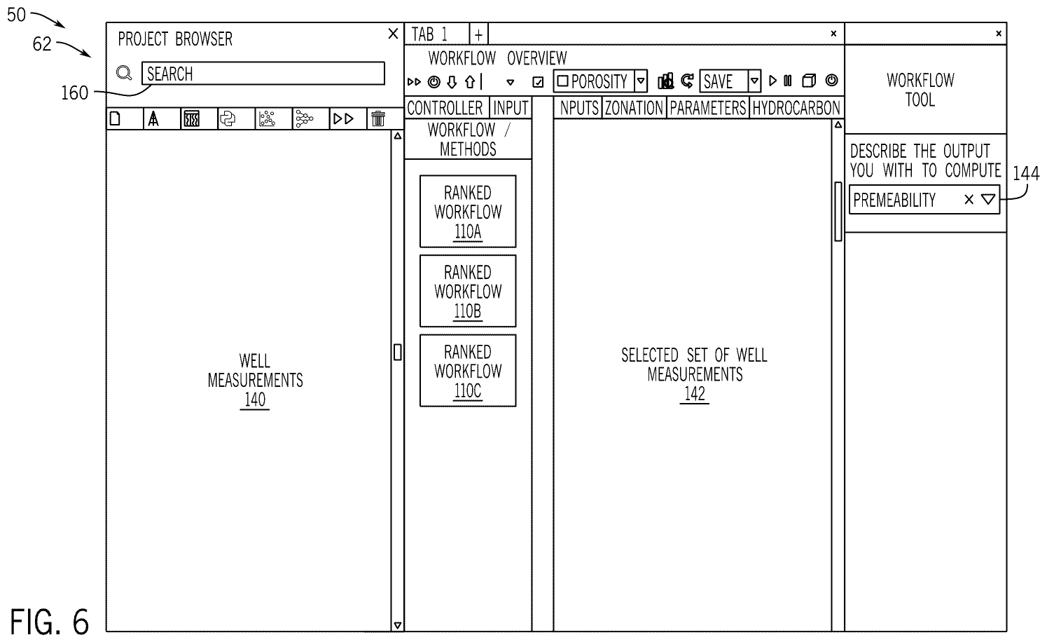

FIG. 6 illustrates a GUI 160 presenting a first ranked result 110A, a second ranked result 110B, and a third ranked result 110C displayed on the workflow system 50. The GUI 160 of FIG. 6 is substantially similar to the GUI 150 of FIG. 5, except that the GUI 160 of FIG. 6 displays a ranked list of workflows including three ranked results. For example, the first ranked result 110A may include an operation (e.g., mathematical formula, equation), a custom tool, and a variable (e.g., parameter), the second ranked result 110B may include first model (e.g., machine learning model), a second model (e.g., porosity model), and a parameter, and the third ranked result 110C may include an operation, the custom tool, a model (e.g., a porosity and saturation model), and a variable. By way of example, the workflow system 50 may determine that the first ranked result 110A may be a better workflow for a user in comparison to the second ranked result 110B and/or the third ranked result 110C based on business rules 106 indicating that workflows implementing custom tools may be ranked before workflows without custom tools. In another example, the workflow system 50 may rank determine that the second ranked result 110B may be a better workflow for the user in comparison to the third ranked result 110C based on historical data 108 indicating that workflows implementing a greater number of models may be ranked earlier in the ranked list of workflows. As the workflow system 50 completes its determination of the predicted set of measurements using each workflow of the ranked list of workflows, the workflow system 50 may populate the GUI 160 with the workflow and the property determined based on the workflow.

FIG. 7 illustrates a flow diagram of an example method 170 for generating a ranked list with one or more workflows. The method 170 will be described as being performed by the workflow system 50, but it should be noted that any suitable processor-based device may be specially programmed to perform any of the steps of the method described herein. It should be understood that the method 170 described below may include some or all the steps illustrated in FIG. 7. Furthermore, it should be understood that the steps of the method 170 may not be performed in the specific order shown illustrated.

At block 172, the workflow system 50 may identify one or more tools. For example, the workflow system 50 may query a software analysis tool 100 and/or a custom analysis tool 102 to identify one or more tools for generating a workflow. The software analysis tool 100 may include built-in workflows and/or tools used for a workflow from a manufacturer, software developer, and/or designer. For example, the software analysis tool 100 may be designed and loaded onto the workflow system prior to use by a user (e.g., customer). For example, the custom analysis tool 102 may be loaded onto and/or accessed by the workflow system 50 after the workflow system 50 may be received and/or used by the user.

At block 174, the workflow system 50 may generate an tool library 104 based on the tools. In particular, the workflow system 50 (e.g., the analysis tool extraction component 94) may identify workflows of the software analysis tool 100 and/or the custom analysis tool 102 to populate the tool library 104 with the workflows. As such, the workflow system 50 may populate the tool library 104 with a variety of different workflows that may be applied to various different sets of well measurements. In other instances, the workflow system 50 may populate the tool library 104 with the software analysis tool 100 and/or the custom analysis tool 102, which may be used to generate one or more workflows. As discussed herein, the workflow system 50 may generate the tool library 104 prior to generation and/or ranking of the workflows. For example, the workflow system 50 may generate at least a portion of the tool library 104 prior to shipping the workflow system 50 to a user. Additionally or alternatively, the tool library 104 may be updated and/or adjusted over time to update and/or adjust current tools in the tool library 104, add new tools to the tool library 104, remove tools from the tool library 104, and so on.

At block 176, the workflow system 50 may receive user input indicative of a property (e.g., input parameter) and a set of well measurements 92. The workflow system 50 may receive user input via an input box 144 of a user interface (e.g., GUI 138, GUI 150, GUI 160) indicative of selecting a property associated with a well in a hydrocarbon site 10 for workflow generation. The workflow system 50 may also receive user input via the user interface indicative of selecting a set of well measurements 92 from a list of well measurements for determining the property.

At block 178, the workflow system 50 may retrieve a set of well measurements 92 based on the user input. For example, the workflow system 50 may retrieve the set of well measurements 92 indicated by the user input. In certain instances, the workflow system 50 may analyze the set of well measurements 92 to identify a characteristic of the well measurement 92, such as a type of well measurement 92, a component used to generate the well measurements 92, a location of the well measurements 92, and so on.

At block 180, the workflow system 50 may determine a plurality of workflows based on the property and the set of well measurements 92. For example, the workflow system 50 (e.g., the workflow generation component 96) may identify one or more workflows from the tool library 104 based on the property and/or characteristics of the selected set of well measurements 92. In another example, the workflow system 50 may generate one or more workflows using tools, such as the software analysis tool 100 and/or the custom analysis tool 102, within the tool library 104 based on the property and/or the selected set of well measurements 92.

At block 182, the workflow system 50 may generate a ranked list with the plurality of workflows based on one or more attributes. As discussed herein, the workflow system 50 may use business rules 106 and/or historical data 108 to determine attributes used to rank the workflows. For example, the workflow system 50 (e.g., the workflow ranking component 98) may use assign a score to each of the workflows based on the attributes and rank the workflows from a highest score to a lowest score. In other instances, the workflow system 50 may use a weighting system to apply the attributes to each workflow, assign a score to each of the workflows, and generate the ranked list of workflows based on the score.

At block 184, the workflow system 50 may determine a predicted set of measurements associated with the property using each workflow of the ranked list. The workflow system 50 may automatically determine a predicted set of measurements using each workflow of the list of workflows without user intervention. In this way, the workflow system 50 may reduce an amount of time and/or an amount of resources used to identify and/or generate workflows, rank the workflows, and determining predicted set of measurements based on each workflow. As such, the workflow system 50 may quickly and easily identify properties related to a well in a hydrocarbon site 10 and/or an area of interest within the well to improve hydrocarbon operations, such as drilling and/or production.

At block 186, the workflow system 50 may instruct a user interface display the ranked list and respective predicted set of measurements. The workflow system 50 may populate a GUI with the ranked list of workflows and properties associated with each workflow of the list. In certain instances, the workflow system 50 may receive user input indicative of adjusting a workflow of the ranked list and update the GUI based on the user input. The workflow system 50 may also store the user input as historical data 108 in the storage component 58 of the workflow system 50. The workflow system 50 may identify one or more attributes from the user input and apply the attributes in subsequent determinations of predicted set of measurements using a similar set of well measurement. For example, the workflow system 50 may apply the attributes when determining the same property for the same type of well measurements.

The technical effect of the disclosed embodiments include generating and ranking workflows that may be employed to determine an output parameter (e.g., property) associated with drilling and/or production operations of a well in a hydrocarbon site. For example, the disclosed embodiments may identify and/or generate the workflows by querying a workflow library (e.g., tool library) based on the output parameter and input dataset (e.g., a set of well measurements). The disclosed embodiments may also identify one or more attributes used to rank the workflows based on stored business rules and/or historical data. For example, the workflows may be ranked to generate a ranked list of workflows based on preferences of a user, preferences of a business associated with the user, based on previous rankings associated with similar datasets and/or properties. The input dataset may be applied to each workflow in the ranked list to determine respective predicted set of measurements associated with the output parameter that may be used to identify areas of interest in a well of the hydrocarbon site. That is, the predicted set of measurements may facilitate determining areas of interest in a well, such as for perforation during a drilling and/or a production operation occurring at the hydrocarbon site. As such, the disclosed embodiments may improve drilling and/or production operations by improving determination of intervals of interest and/or areas within the wells for perforation.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under means-plus function. However, for any claims containing elements designated in any other manner, it is intended that such elements are not to be interpreted under means-plus function.

1. A system comprising:
processing circuitry; and
memory storing instructions, wherein the instructions, when executed by the processing circuitry, cause the processing circuitry to:
identify one or more tools configured to generate one or more workflows for analyzing one or more datasets associated with one or more well operations;
generate a tool library based on the tools;
receive user input indicative of a property and a set of well measurements;
determine a plurality of workflows based on the property, the set of well measurements, and the tool library;
generate a ranked list comprising the plurality of workflows based on one or more attributes;
determine a predicted set of measurements for each workflow of the ranked list; and
instruct a user interface to display the ranked list and the predicted set of measurements for each workflow of the ranked list of workflows.

2. The system of claim 1, wherein the instructions, when executed by the processing circuitry, cause the processing circuitry to determine the one or more attributes based on business inputs received via the user interface and historical data stored in a database.

3. The system of claim 2, wherein the instructions, when executed by the processing circuitry, cause the processing circuitry to:
receive an indication of adjusting at least one workflow of the ranked list; and
store the indication as historical data in the database.

4. The system of claim 1, wherein the instructions, when executed by the processing circuitry, cause the processing circuitry to instruct one or more components within a well associated with the set of well measurements to perform or adjust one or more operations based on the predicted set of measurements.

5. The system of claim 1, wherein the tools comprises one or more custom tools received from an external device.

6. The system of claim 1, wherein the instructions, when executed by the processing circuitry, cause the processing circuitry to determine the predicted set of measurements for each workflow of the ranked list by applying the set of well measurements to each workflow of the ranked list of workflows.

7. A system comprising:
processing circuitry; and
memory storing instructions, wherein the instructions, when executed by the processing circuitry, cause the processing circuitry to:
receive user input indicative of a property and a set of well measurements stored in a database via a user interface on a display;
generate a plurality of workflows for determining the property using the set of well measurements based on a tool library storing one or more tools for generating a workflow;
generate a ranked list comprising the plurality of workflows based on one or more attributes;
determine a respective predicted set of measurements associated with the property for each respective workflow of the plurality of workflows; and
output each predicted set of measurements with the respective workflow in an order indicated by the ranked list on the display.

8. The system of claim 7, wherein the instructions, when executed by the processing circuitry, cause the processing circuitry to:
receive at least one custom analysis tool from an external device; and
generate or update the tool library with the at least one custom analysis tool and one or more built-in workflow tools stored in a database.

9. The system of claim 7, wherein the instructions, when executed by the processing circuitry, cause the processing circuitry to:
retrieve one or more business rules and historical data from a database; and
determine the one or more attributes based on the business rules and the historical data.

10. The system of claim 9, wherein the instructions, when executed by the processing circuitry, cause the processing circuitry to receive the one or more business rules from an external device or a cloud server.

11. The system of claim 9, wherein the instructions, when executed by the processing circuitry, cause the processing circuitry to:
receive user input indicative of adjusting a ranking of a workflow of the ranked list of workflows via the user interface; and
store the user input as the historical data.

12. The system of claim 7, wherein the instructions, when executed by the processing circuitry, cause the processing circuitry to:
generate a first workflow of the plurality of workflows by assembling one or more tools from the tool library based on the property and the set of well measurements.

13. The system of claim 12, wherein the instructions, when executed by the processing circuitry, cause the processing circuitry to:
receive user input indicative of selecting a workflow from the ranked list; and
populate the user interface with the workflow, the respective property associated with the workflow, and tools of the workflow.

14. The system of claim 7, wherein the instructions, when executed by the processing circuitry, cause the processing circuitry to:
populate the user interface with a dropdown menu comprising a plurality of properties for determination; and
receive the user input indicative of the property based on selection of the property from the plurality of properties of the dropdown menu.

15. The system of claim 7, wherein the instructions, when executed by the processing circuitry, cause the processing circuitry to:
assign a score to each workflow of the plurality of workflows based on the one or more attributes; and
generate the ranked list comprising the plurality of workflows ranked from a highest score to a lowest score.

16. The system of claim 7, wherein the tool library comprises a model, an equation, a variable, a filter, or any combination thereof.

17. The system of claim 7, wherein the instructions, when executed by the processing circuitry, cause the processing circuitry to instruct one or more components within a well associated with the set of well measurements to perform or adjust an operation based on the predicted set of measurements.

18. A method comprising:
identifying, via a processor, one or more tools configured to generate one or more workflows for analyzing one or more datasets associated with one or more well operations;
generating, via the processor, a tool library based on the one or more tools;
receiving, via the processor, user input indicative of a property and a set of well measurements;
retrieving, via the processor, the set of well measurements based on the user input;
determining, via the processor, a plurality of workflows based on the property, the set of well measurements, and the tool library;
generating, via the processor, a ranked list comprising the plurality of workflows based on one or more attributes;
determining, via the processor, a predicted set of measurements for each workflow of the ranked list; and
instructing, via the processor, a user interface to display the ranked list and the predicted set of measurements for each workflow of the ranked list of workflows.

19. The method of claim 18, comprising:
retrieving, via the processor, one or more business rules and historical data from a database; and
determining, via the processor, the one or more attributes based on the business rules and the historical data.

20. The method of claim 18, comprising:
receiving, via the processor, user input indicative of adjusting a ranking of a workflow of the ranked list of workflows via the user interface; and
storing, via the processor, the user input as the historical data.
